(19) United States
(12) Patent Application Publication
(10) Pub. No.: US 2017/0053238 A1
(43) Pub. Date: Feb. 23, 2017

(54) SYSTEMS AND METHODS FOR IMPROVING THE MONITORING OF VITALS DATA ASSOCIATED WITH HEALTHCARE CARGO IN TRANSIT

(71) Applicants: Andrea C. Baur, Eagan, MN (US); Joann E. Jancik, Eagan, MN (US); Laura L. Kvistad, Eagan, MN (US)

(72) Inventors: Andrea C. Baur, Eagan, MN (US); Joann E. Jancik, Eagan, MN (US); Laura L. Kvistad, Eagan, MN (US)

(73) Assignee: UNISYS CORPORATION, Blue Bell, PA (US)

(21) Appl. No.: 14/830,116

(22) Filed: Aug. 19, 2015

(51) Int. Cl. G06Q 10/08

(52) U.S. Cl. CPC G06Q 10/0837

(57) ABSTRACT

Systems and methods for improving the monitoring of vitals data associated with healthcare cargo in transit are disclosed. Embodiments may include identifying the presence of healthcare cargo based, at least in part, on at least one of a product code and special handling code associated with the healthcare cargo. Embodiments may also include receiving, at a first time instant, vitals data associated with the healthcare cargo. Embodiments may further include storing the received vitals data in memory accessible by the processor. Embodiments may also include determining a first time interval which specifies the approximate time between the first time instant when the vitals data was received and a subsequent time instant at which subsequent vitals data is to be received. Embodiments may further include outputting a notice when a second time interval has elapsed, wherein the second time interval is less than the first time interval.

### FIELD OF THE DISCLOSURE

The instant disclosure relates to logistics management systems. More specifically, this disclosure relates to logistics management systems configured to improve the monitoring of vitals data associated with healthcare cargo in transit.

### BACKGROUND

Airlines handle temperature-sensitive healthcare cargo, such as pharmaceutical (Pharma) products, which are typically contained in Shipper-Loaded Unit Load Devices (SLULDs) that have integrated, temperature-monitoring hardware. The monitoring hardware can display critical data externally, typically on an LCD screen. The data displayed is the real-time, internal temperature of the ULD and voltage of the batteries used for the ULD. Also of importance is the amount of dry ice present, if any. This information is recorded manually and a paper copy is kept at each station involved in the handling or transportation of the healthcare cargo shipment, such as an origin, transit, or destination station, for possible inquires or claims.

At a station, there can be many SLULDs containing temperature-sensitive healthcare cargo, increasing the potential for mishandling of the healthcare cargo. In particular, businesses have indicated that the effort to manually track all the required data is challenging and that manual tracking on paper leaves room for error, such as being misplaced or being lost. Thus, because healthcare cargo typically must be kept at a specific/constant temperature throughout transit, if accurate tracking is not completed in a timely manner, an airline's service level and the integrity of the healthcare cargo itself may be jeopardized.

### SUMMARY

Logistics management systems may be developed to provide computing resources to aid in the handling of healthcare cargo, such as by aiding the processing, scheduling, coordinating, monitoring, and tracking of the healthcare cargo. In particular, a method for improving the monitoring of vitals data associated with healthcare cargo in transit may include identifying, by a processor, the presence of healthcare cargo based, at least in part, on at least one of a product code and special handling code associated with the healthcare cargo. The method may also include receiving, by the processor, at a first time instant, vitals data associated with the healthcare cargo. The method may further include storing, by the processor, the received vitals data in memory accessible by the processor. The method may also include determining, by the processor, a first time interval which specifies the approximate time between the first time instant when the vitals data was received and a subsequent time instant at which subsequent vitals data is to be received. The method may further include outputting, by the processor, a notice when a second time interval has elapsed, wherein the second time interval is less than the first time interval.

According to another embodiment, a computer program product may include a non-transitory, computer-readable medium comprising instructions which, when executed by a processor of a computing system, cause the processor to perform the step of identifying the presence of healthcare cargo based, at least in part, on at least one of a product code and special handling code associated with the healthcare cargo. The medium may also include instructions which, when executed by a processor of a computing system, cause the processor to perform the step of receiving, at a first time instant, vitals data associated with the healthcare cargo. The medium may further include instructions which, when executed by a processor of a computing system, cause the processor to perform the step of storing the received vitals data in memory accessible by the processor. The medium may also include instructions which, when executed by a processor of a computing system, cause the processor to perform the step of determining a first time interval which specifies the approximate time between the first time instant when the vitals data was received and a subsequent time instant at which subsequent vitals data is to be received. The medium may further include instructions which, when executed by a processor of a computing system, cause the processor to perform the step of outputting a notice when a second time interval has elapsed, wherein the second time interval is less than the first time interval.

According to yet another embodiment, an apparatus may include a memory and a processor coupled to the memory. The processor may be configured to execute the step of identifying the presence of healthcare cargo based, at least in part, on at least one of a product code and special handling code associated with the healthcare cargo. The processor may also be configured to execute the step of receiving, at a first time instant, vitals data associated with the healthcare cargo. The processor may be further configured to execute the step of storing the received vitals data in memory accessible by the processor. The processor may also be configured to execute the step of determining a first time interval which specifies the approximate time between the first time instant when the vitals data was received and a subsequent time instant at which subsequent vitals data is to be received. The processor may be further configured to execute the step of outputting a notice when a second time interval has elapsed, wherein the second time interval is less than the first time interval.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a block diagram illustrating a network-based environment for managing and tracking shipments according to one embodiment of the disclosure.

FIG. 2 is a block diagram illustrating a logistics management system according to one embodiment of the disclosure.

FIG. 3 is a flow chart illustrating a method for improving the monitoring of vitals data associated with healthcare cargo in transit according to one embodiment of the disclosure.

FIG. 4 is a flow chart illustrating process flows which may be implemented by a logistics management system as part of its implementation of the method of FIG. 3 for improving the monitoring of vitals data associated with healthcare cargo in transit according to one embodiment of the disclosure.

FIG. 5 is a screen shot illustrating an interface which may be displayed by the logistics management system to display and receive vitals data associated with healthcare cargo according to one embodiment of the disclosure.

FIG. 6 is a screen shot illustrating an interface which may be displayed by the logistics management system to display an alert according to one embodiment of the disclosure.

FIG. 7 is a block diagram illustrating a computer system according to one embodiment of the disclosure.

### DETAILED DESCRIPTION

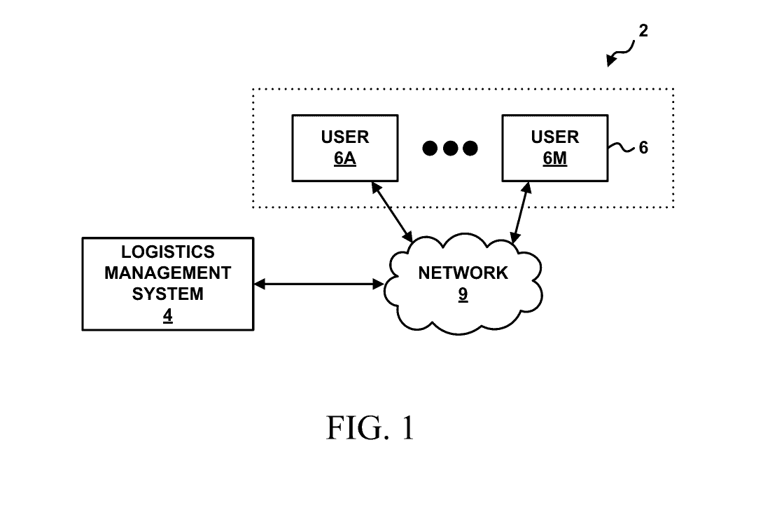

FIG. 1 is a block diagram illustrating an exemplary network-based environment 2 in which logistics management system 4 provides network-based management of freight shipments, such as healthcare cargo. As described in detail herein, logistics management system 4 provides a task-oriented user interface with which authorized users 6A-6M (collectively “users 6”) of an airline interact with the system to perform a wide range of tasks associated with shipment management. A user may be, for example, a station manager, office personnel, airline personnel, shipper personnel, warehouse staff, space control staff, and the like. Exemplary tasks include capture of shipment data, such as the capture of vitals data associated with healthcare cargo, tracking and tracing shipments, capacity control, container control, terminal management, cash management, consolidation, and other common freight tasks.

Logistics management system 4 presents the user interface as a graphical set of interrelated screens. Regardless of the selected task, logistics management system 4 presents the user interface in a consistent manner that allows the user to perform the task by interacting with a single input screen. Specifically, logistics management system 4 presents each screen to include an item selection region, one or more activity regions, and an action region.

In general, the item selection region allows the user to identify one or more “items,” e.g., a cargo item, a person, an event, a flight, or the like. The activity regions of the screen allow the user to provide input data for a defined set of activities or steps associated with the task, i.e., activities necessary for completion of the overall task. The action region allows the user to perform one or more actions on the item specified with item selection region based on the data specified within activity regions, thereby completing an overall shipment management task with a single action. In this manner, the user need not interact with multiple screens to complete the various activities associated with an overall task.

The task-oriented nature of the interface provided by logistics management system 4 facilitates ease of use by the users, even by relatively untrained individuals. As a result, logistics management system 4 may achieve a reduction in human-related errors, as well reduced training costs. Moreover, by allowing the user to initiate multiple cargo management activities with a single entry, the system may achieve increased employee productivity.

Each user typically accesses logistics management system 4 via network 9 using a remote computing device having suitable communication software, e.g., a web browser. A user may access logistics management system 4 using a network-enabled computing device, such as a workstation, personal computer, laptop computer, or a personal digital assistant (PDA). The communication device executes communication software, such as a web browser, in order to communicate with logistics management system 4.

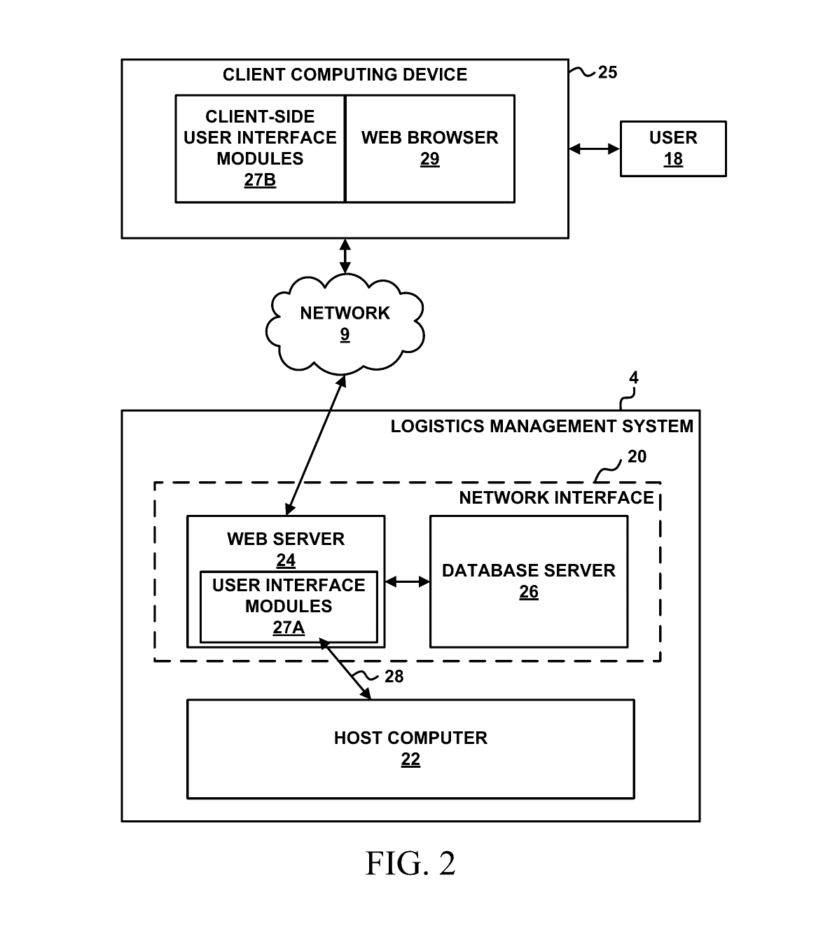

FIG. 2 is a block diagram illustrating an exemplary embodiment of logistics management system 4 in further detail. In the exemplary embodiment, logistics management system 4 includes a host computer 22 coupled to network 9 via network interface 20. The term “couple,” and its variants disclosed herein, may refer to any means of coupling two or more components, such as mechanical, wired, or wireless coupling. In general, host computer 22 provides a computing platform for hosting shipment management services for logistics service providers. In one embodiment, host computer system 22 may comprise a mainframe executing logistics management software.

Network interface 20 comprises one or more computing devices, e.g., web server 24 and database server 26, that cooperate to provide a seamless, network-based interface by which remote user 18 access host computer 22. Although host computer 22, web server 24, and database server 26 are illustrated separately in FIG. 2 for exemplary purposes, logistics management system 4 may be realized by a single computing device or a plurality of cooperating computing devices.

Web server 24 provides a web-based interface by which an authorized user 18 communicates with logistics management system 4 via network 9. In one configuration, web server 24 executes web server software, such as software marketed by Microsoft Corporation under the trade designation “INTERNET INFORMATION SERVER.” As such, web server 24 provides an environment for interacting with remote user 18 via user interface modules 27A, 27B (collectively “user interface modules 27”). As described in detail below, user interface modules 27 provide a task-oriented interface with which user 18 interacts to perform a wide-range of tasks associated with shipment management. User interface modules 27 may include Active Server Pages, web pages written in hypertext markup language (HTML) or dynamic HTML, Active X modules, Java scripts, Java Applets, Distributed Component Object Modules (DCOM), and the like.

Moreover, user interface modules 27 may comprise “server side” user interface modules 27A that execute within an operating environment provided by web server 24, “client-side” user interface modules 27B that are downloaded to and executed on a client computing device 25 of remote user 18, or combinations thereof. Client-side user interface modules 27B could, for example, include Active X components or Java scripts executed by web browser 29 executing on client computing device 25.

User interface modules 27 interact with data base server 26 to retrieve user-specific information. For example, user 18 may interact with logistics management system 4 to define a variety of preferences for controlling operation of user interface modules 27. Database server 26 may provide an operating environment for a database management system (DBMS) for storing the user-defined preferences. The database management systems may be a relational (RDBMS), hierarchical (HDBMS), multidimensional (MDBMS), object oriented (ODBMS or OODBMS) or object relational (ORDBMS) database management system.

In view of exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by various aspects of the systems disclosed herein.

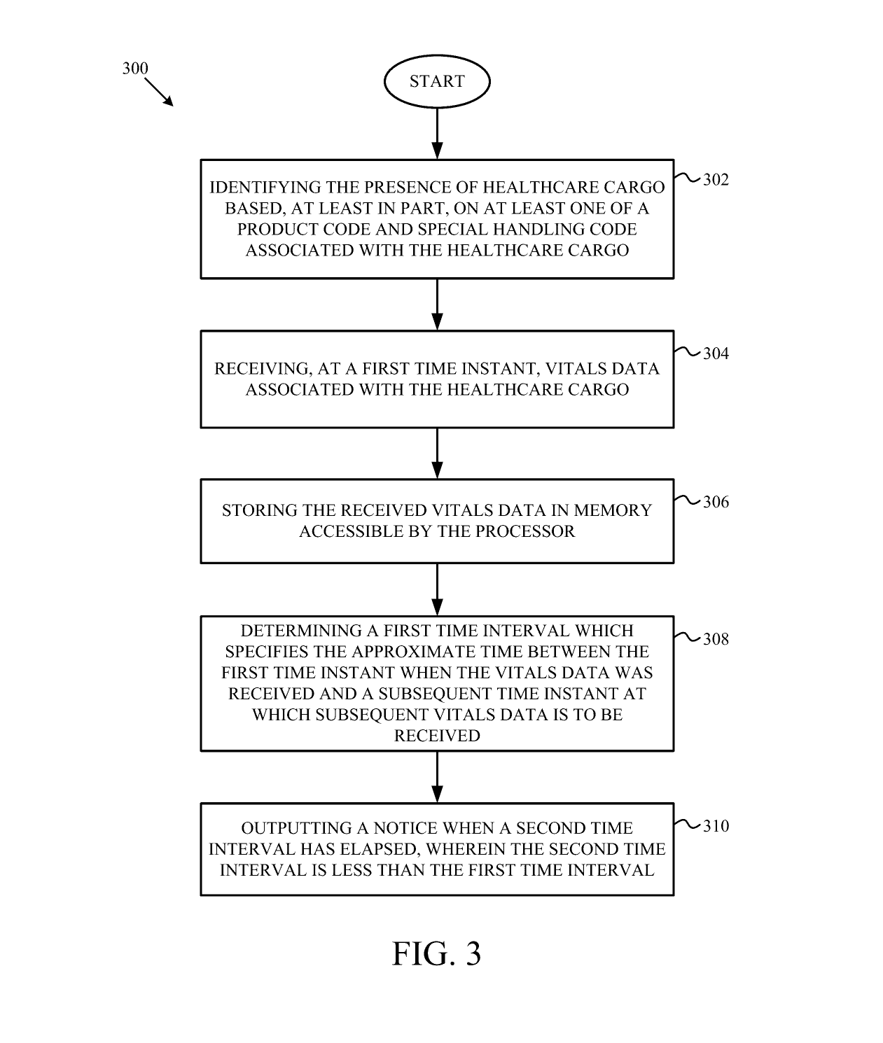

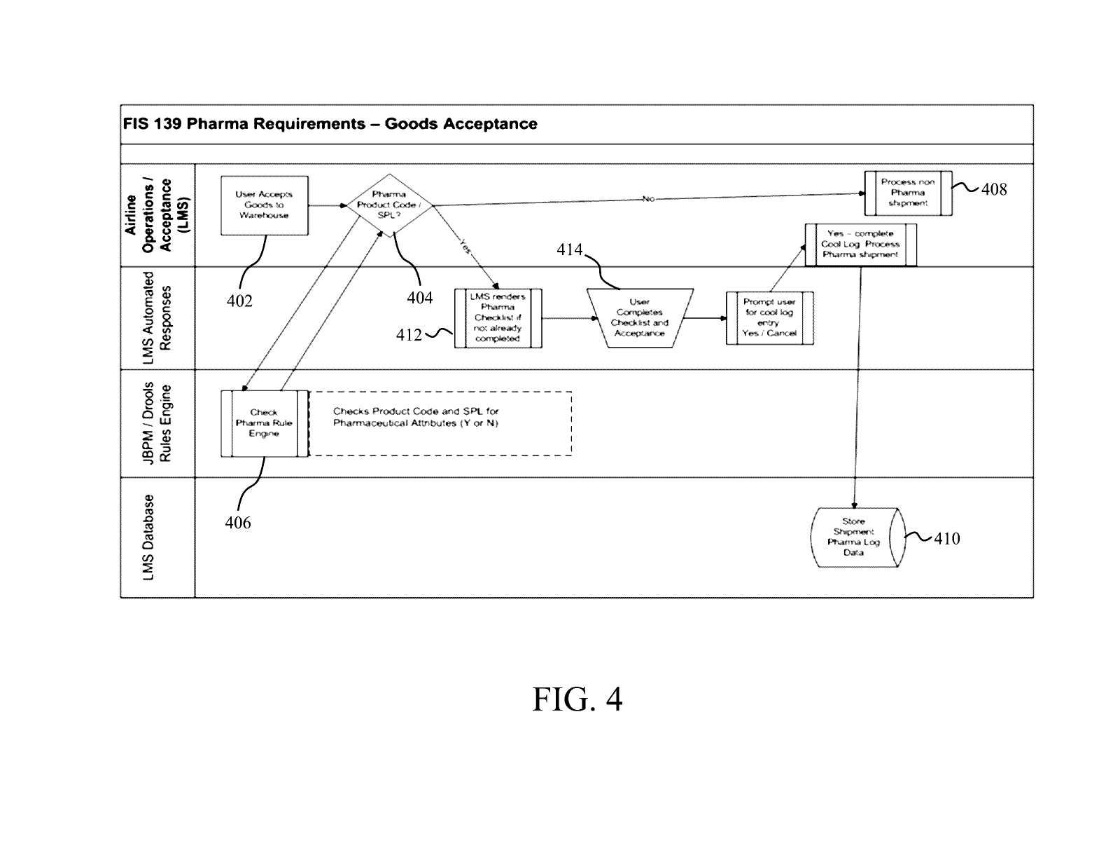

FIG. 3 is a flow chart illustrating a method for improving the monitoring of vitals data associated with healthcare cargo in transit according to one embodiment of the disclosure. It is noted that embodiments of method 300 may be implemented in accordance with the systems and embodiments described herein with respect to FIGS. 1-2 and FIG. 7. For example, embodiments of method 300 may be implemented by computer system 700. In general, embodiments of method 300 may be implemented by other similar systems without deviating from this disclosure so long as the systems, whether directly or indirectly, support the operations as described herein. To aid in the description of the method of FIG. 3, FIG. 4 provides an illustration of embodiments of the method disclosed in FIG. 3. In particular, FIG. 4 is a flow chart illustrating process flows which may be implemented by a logistics management system as part of its implementation of the method for improving the monitoring of vitals data associated with healthcare cargo in transit according to one embodiment of the disclosure.

Specifically, method 300 includes, at block 302, identifying, by a processor, the presence of healthcare cargo based, at least in part, on at least one of a product code and special handling code associated with the healthcare cargo. In particular, airlines may choose to identify healthcare cargo through the use of product codes, special handling codes, or both. For example, in one embodiment, product codes may be used to identify healthcare cargo when an airline seeks to control the handling of the healthcare cargo at the product code level. In another embodiment, special handling codes may be used to identify healthcare cargo when the airline seeks to control the handling of the healthcare cargo at the special handling code level.

As illustrated in FIG. 4, goods may be accepted into the logistics management system at block 402. In some embodiments, the association of the healthcare cargo (the SLULD) with a product code or a special handling code may be pre-established by the shipper of the healthcare cargo. Therefore, in some embodiments, during, or soon thereafter, acceptance of the SLULD by the logistics management system, the SLULD may be identified as healthcare cargo if the SLULD is associated with a healthcare cargo product code or if the SLULD is associated with a healthcare cargo special handling code. For example, at block 404, the logistics management system may identify the presence of healthcare cargo based on the product code and/or the special handling code associated with the healthcare cargo.

As illustrated in FIG. 4, in some embodiments, identification of the presence of the healthcare cargo based on the product code and/or the special handling code may include, at block 406, cross-referencing the product code and/or the special handling code with information stored within the logistics management system. For example, the logistics management system may have stored within it, or have accessible to it, a healthcare cargo list which contains a list of healthcare SLULDs that require the recording of healthcare cargo vitals data. Accordingly, in some embodiments, the logistics management system may cross-reference the accepted cargo's associated product code and/or the special handling code with the healthcare cargo list when seeking to identify the presence of healthcare cargo. In some embodiments, the logistics management system may also display, for example, via a user interface, the healthcare cargo log for viewing by a user of the logistics management system.

In some embodiments, when a logistics management system determines that the SLULD is not healthcare cargo, the system may process the SLULD as non-healthcare cargo, as indicated at block 408. In other words, the logistics management system may forego the implementation of cargo vitals data monitoring features that are implemented for healthcare cargo, although the logistics management system may still implement certain vitals data monitoring features if the product code and/or special handling code associated with the cargo, although not identifying the cargo as healthcare cargo, still require the implementation of such features.

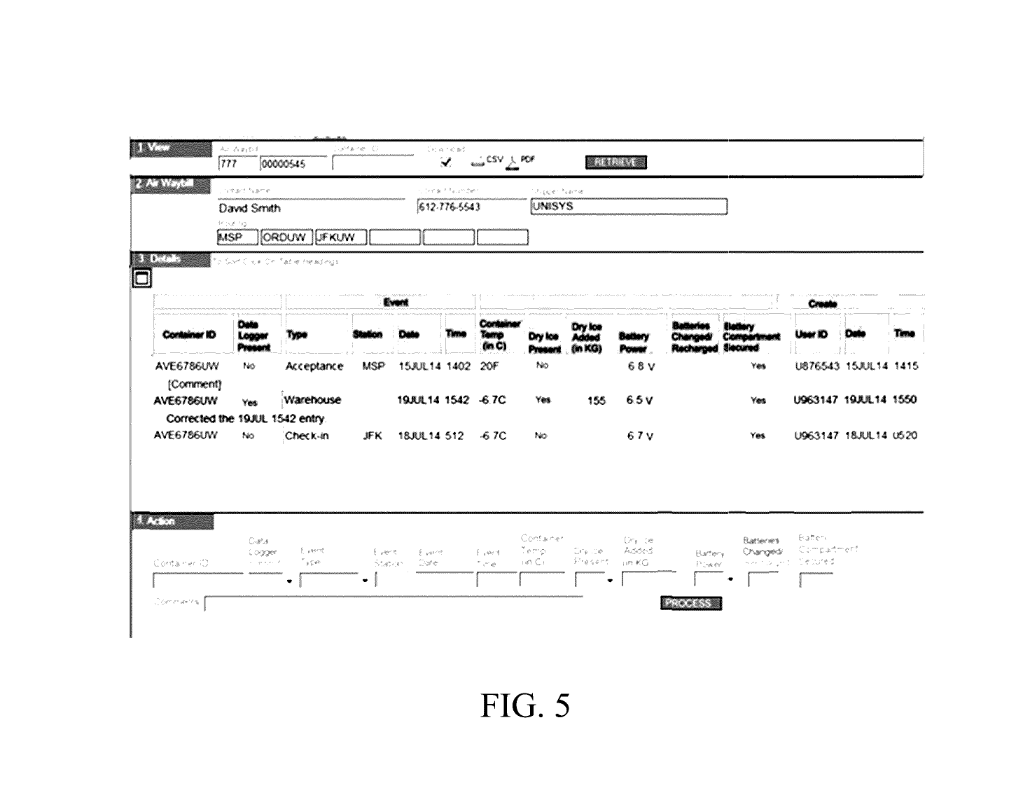

Returning to FIG. 3, at block 304, method 300 includes receiving, by the processor, at a first time instant, vitals data associated with the healthcare cargo. In some embodiments, receiving may include receiving the vitals data from a user via a user interface coupled to a processor of the logistics management system. For example, FIG. 5 is a screen shot illustrating an interface which may be displayed by the logistics management system to display and receive vitals data associated with healthcare cargo according to one embodiment of the disclosure. In some embodiments, the vitals data displayed and which can be received as input may include the temperature within the healthcare cargo, an indication of whether dry ice is present within the healthcare cargo, battery power and/or voltage of the batteries used for the healthcare cargo, an indication of whether the batteries have been changed or recharged, and an indication of whether the battery compartment is secured. In some embodiments, the temperature readings may be received from portable wireless temperature scanners. However, numerous other types of data may be displayed and/or received without deviating from this disclosure so long as the data is associated with the healthcare cargo and capable of being displayed and/or received as disclosed herein.

Method 300 includes, at block 306, storing, by the processor, the received vitals data in memory accessible by the processor. For example, as illustrated at block 410 of FIG. 4, the logistics management system may store the healthcare cargo log (Pharma Log) after receiving vitals data. The memory accessible by the processor may be memory within the logistics management system.

At block 308, method 300 includes determining, by the processor, a first time interval which specifies the approximate time between the first time instant when the vitals data was received and a subsequent time instant at which subsequent vitals data is to be received. In some embodiments, determining the first time interval may include determining the first time interval based, at least in part, on at least one of user input and a pre-determined time interval set based, at least in part, on the at least one of a product code and special handling code associated with the healthcare cargo. For example, user input provided by, for example, airline, shipper, or transit station personnel, may be used to establish the first time interval by setting a time interval parameter which may control the approximate time in minutes between scheduled checks of the vitals data associated with healthcare cargo. Each distinct healthcare cargo shipment may be associated with a distinct time interval parameter. After a time interval parameter has been set for a healthcare cargo shipment, the time interval may be stored by the logistics management system within the logistics management system. When vitals data associated with a particular healthcare cargo is received by the logistics management system at a time instant, the logistics management system may determine the first time interval by retrieving the pre-determined (pre-set) time interval associated with the healthcare cargo.

In some embodiments, each time vitals data is recorded for healthcare cargo the logistics management system may automatically reset a time and date parameter that specifies the time and date when a subsequent recording of the vitals data of the healthcare cargo should be received by the logistics management system. For example, after the logistics management system receives, at a first time instant, vitals data associated with the healthcare cargo, the logistics management system may set the time and date of the next scheduled check by adding the time value defined by the pre-determined time interval parameter to the first time instant. In other embodiments, after the logistics management system receives, at a first time instant, vitals data associated with the healthcare cargo, a user may manually select a different time and date parameter, such as a delay parameter, to compensate for various other factors, such as modifications to the healthcare cargo.

In some embodiments, a user may set a delay parameter which may modify the time and date at which the next scheduled check of the vitals data associated with the healthcare cargo may be required to occur. For example, in some embodiments, a timer that gets cross-referenced with the pre-determined time interval associated with a healthcare cargo may begin running when the cargo is accepted or during check-in of the cargo. However, when during acceptance or check-in of the cargo item the logistics management system does not receive vitals data because the user did not enter the vitals data associated with the cargo, the timer is reset when the user subsequently records the vitals data in the logistics management system. Therefore, in some embodiments, a user may select the delay parameter to set the next time and date for a vital data recording to a time and date that is typically a short period to allow for the completion of the acceptance or check-in process. For example, the user may set the delay parameter to a time value that typically represents the time between when the healthcare cargo arrives at the warehouse and when the first vitals data check occurs. For example, if it typically takes twenty minutes to complete the acceptance or check-in process, the user may set the delay parameter to twenty minutes.

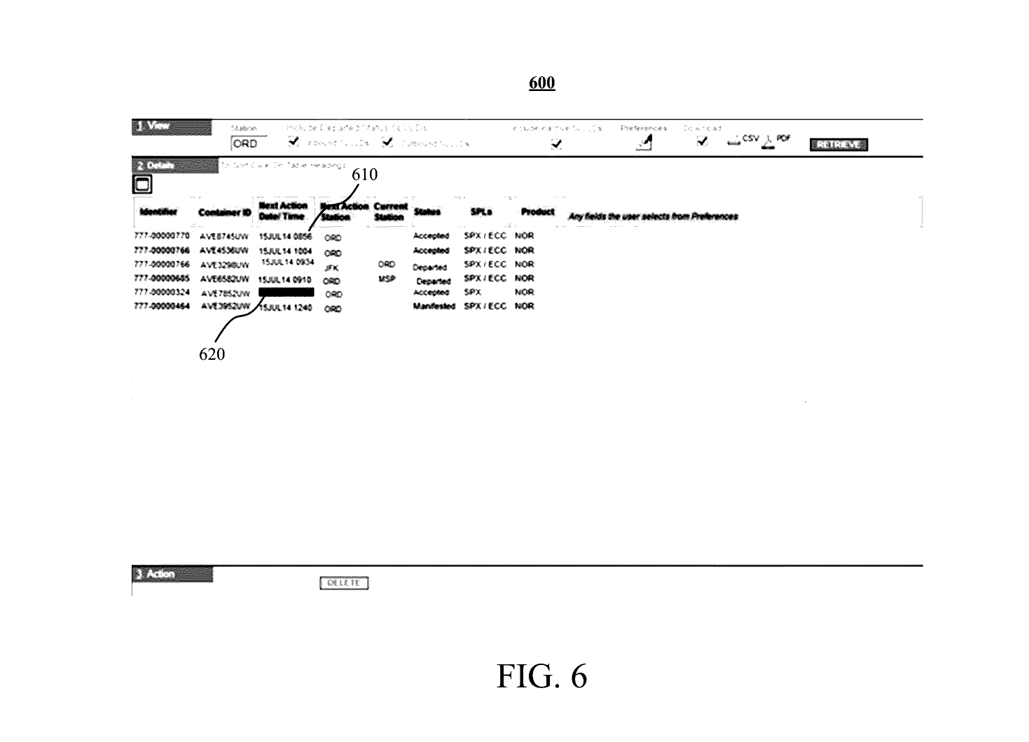

Method 300 includes, at block 310, outputting, by the processor, a notice when a second time interval is close to elapsing or has elapsed, wherein the second time interval may be less than the first time interval. In general, the second time interval may correspond to a different time interval than the first time interval. For example, in some embodiments, the second time interval may be less than the first time interval. In another embodiment, the second time interval may be more time than the first time interval. In yet another embodiment, the second time interval may be equal to the first time interval. In some embodiments, the notice may include an e-mail alert, a display indicator, or a combination of both. As an example, and not limitation, FIG. 6 is a screen shot illustrating an interface which may be displayed by the logistics management system to display an alert according to one embodiment of the disclosure. In the embodiment of FIG. 6, the “Next Action Date/Time” field for a shipment of healthcare cargo may be highlighted in yellow to output the alert. The display output of the alert, i.e., the yellow highlight indicator 610 on the healthcare cargo shipment list 600, may indicate to a user that the first time interval for the associated healthcare cargo is close to elapsing or has elapsed, and therefore the vitals data associated with the healthcare cargo may soon need to be checked and recorded. In general, the notice may include any alerting message without departing from this disclosure so long as the alerting message is capable of being output by the logistics management system. In addition, in some embodiments, the notice may be output when the initial vitals entry was delayed and the first time interval has elapsed.

In some embodiments, the second time interval, which may be an alerting message time interval, may be determined based on an alert parameter set by a user in addition to other time parameters set by a user, such as the time interval parameter and the delay parameter. According to an embodiment, the logistics management system may present an interface to a user through which the user can set the alert parameter. The alert parameter may represent an amount of time before the next date and time vitals data for healthcare cargo must be checked. Therefore, in some embodiments, the logistics management system may determine the second time interval by subtracting the time represented by the alert parameter from the time represented by the time interval parameter. Because the second time interval is determined by subtracting time from the time interval parameter, which may serve as the first time interval, the second time interval may be smaller than the first time interval. As an example, and not limitation, the time interval parameter may be set to ten hours and the alert parameter may be set to thirty minutes. Therefore, the second time interval may be determined by the logistics management system to be nine hours and thirty minutes. Each time vitals data is checked and entered into the logistics management system, the logistics management system may set an alert date and time to the time instant that is nine hours and thirty minutes after the time instant when the vitals data was checked. Accordingly, after the logistics management system receives vitals data associated with healthcare cargo, the logistics management system may output a notice when the alert date and time is reached, i.e., nine hours and thirty minutes later, to indicate that vitals data for the healthcare cargo will need to be checked in thirty minutes.

In some embodiments, the logistics management system may have more than one alert parameter. For example, the logistics management system may include two settable alert parameters: one associated with an e-mail alert, and another associated with a display alert. In general, there may be any number of alert parameters without departing from this disclosure.

According to an embodiment, the logistics management system may also display an alert when the first time interval has elapsed, indicating that a required checking and recording of vitals data for the healthcare cargo associated with the first time interval has not been performed. As an example, and not limitation, the red highlight indicator 620 illustrated in FIG. 6 may be output on the healthcare cargo shipment list 600 to indicate that a date and time event at which vitals data associated with the healthcare cargo has lapsed without the vitals data being checked and recorded.

When a user desires to check and record vitals data associated with healthcare cargo, such as, for example, during acceptance or check-in of healthcare cargo or after receiving an e-mail alert, the logistics management system may present to the user an interface with which the user may interact and through which the logistics management system may receive the vitals data. In some embodiments, the user may interact with the logistics management system to prepare the logistics management system to receive new vitals data for healthcare cargo. In one embodiment, the logistics management system may access vitals data associated with the healthcare cargo that has been stored by the logistics management system. The logistics management system may also display the accessed vitals data, which may include previously-received vitals data associated with the healthcare cargo, for review by the user.

In some embodiments, as part of the process of preparing to receive vitals data associated with the healthcare cargo, the logistics management system may display a checklist associated with the healthcare cargo that provides a list of items which may be checked and recorded as vitals data associated with the healthcare cargo. For example, with reference to the embodiment illustrated in FIG. 4, at block 412 the logistics managements system may display a checklist associated with the healthcare cargo. The checklist may be displayed during the acceptance or check-in time or during a subsequent event in which the vitals data is checked and recorded. In some embodiments, the user may check the vitals data associated with the healthcare cargo in accordance with the displayed checklist and the logistics management system may receive the recorded vitals data for storage within the logistics management system. For example, with reference to the embodiment illustrated in FIG. 4, at block 414 the logistics management system may receive the vitals data after the user completes the checking and recording of vitals data listed in the checklist.

In some embodiments, the logistics management system may also archive a log of the vitals data received for a healthcare cargo shipment. The logistics management system may archive the log to access the information contained in the log after the healthcare cargo has been delivered to its destination. The archiving of the log in which the vitals data associated with the healthcare cargo has been stored may improve customer service by providing a record which identifies the vitals data associated with the healthcare cargo while the cargo was in transit and that therefore removes any doubt about mishandling of the healthcare cargo before the healthcare cargo reached its destination.

The schematic flow chart diagrams of FIGS. 3-4 are generally set forth as logical flow chart diagrams. As such, the depicted order and labeled steps are indicative of one embodiment of the disclosed methods. Other steps and methods may be conceived that are equivalent in function, logic, or effect to one or more steps, or portions thereof, of the illustrated methods. Additionally, the format and symbols employed are provided to explain the logical steps of the methods and are understood not to limit the scope of the methods. Although various arrow types and line types may be employed in the flow chart diagrams, they are understood not to limit the scope of the corresponding methods. Indeed, some arrows or other connectors may be used to indicate only the logical flow of the methods. For instance, an arrow may indicate a waiting or monitoring period of unspecified duration between enumerated steps of the depicted methods. Additionally, the order in which a particular method occurs may or may not strictly adhere to the order of the corresponding steps shown.

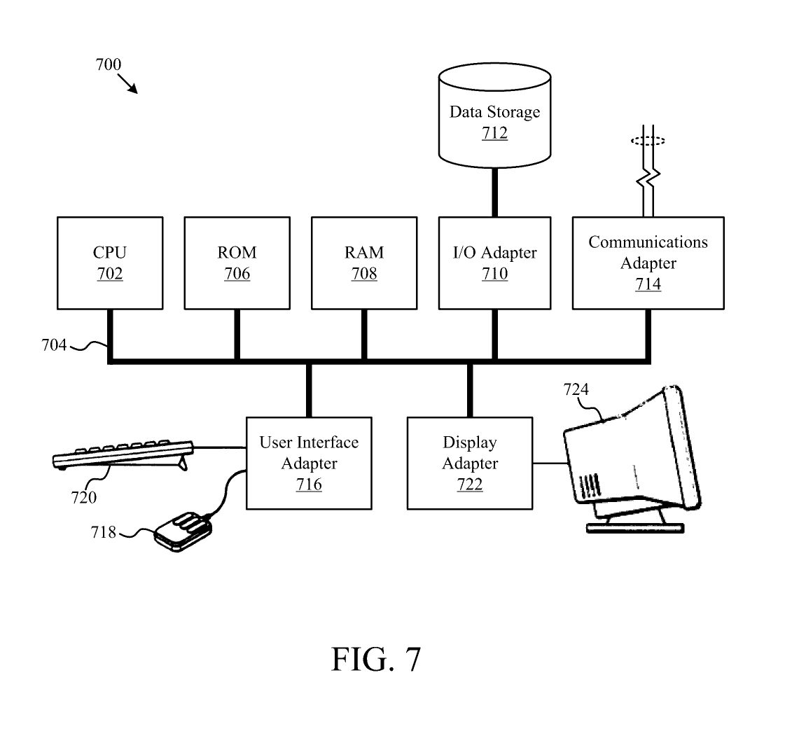

FIG. 7 illustrates a computer system 700 adapted according to certain embodiments of a server and/or a user interface device. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 may also include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to a network, which may be one or more of a LAN, WAN, and/or the Internet. The user interface adapter 716 couples user input devices, such as a keyboard 720, a pointing device 718, and/or a touch screen (not shown) to the computer system 700. The display adapter 722 may be driven by the CPU 702 to control the display on the display device 724. Any of the devices 702-722 may be physical and/or logical.

The applications of the present disclosure are not limited to the architecture of computer system 700. Rather the computer system 700 is provided as an example of one type of computing device that may be adapted to perform the functions of a server and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, in some embodiments, aspects of the computer system 700 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data may be configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for improving the monitoring of vitals data associated with healthcare cargo in transit, comprising:
identifying, by a processor, the presence of healthcare cargo based, at least in part, on at least one of a product code and special handling code associated with the healthcare cargo;
receiving, by the processor, at a first time instant, vitals data associated with the healthcare cargo;
storing, by the processor, the received vitals data in memory accessible by the processor;
determining, by the processor, a first time interval which specifies the approximate time between the first time instant when the vitals data was received and a subsequent time instant at which subsequent vitals data is to be received; and
outputting, by the processor, a notice when a second time interval has elapsed, wherein the second time interval is less than the first time interval.

2. The method of claim 1, further comprising displaying previously received vitals data associated with the healthcare cargo.

3. The method of claim 1, wherein receiving comprises receiving the vitals data from a user via a user interface coupled to the processor.

4. The method of claim 1, wherein the vitals data comprises at least one of a temperature within the healthcare cargo, an indication of whether dry ice is present within the healthcare cargo, battery power and/or voltage of batteries used for the healthcare cargo, an indication of whether the batteries have been changed or recharged, and an indication of whether the battery compartment is secured.

5. The method of claim 1, wherein determining the first time interval comprises determining the first time interval based, at least in part, on at least one of user input and a pre-determined time interval set based, at least in part, on the at least one of a product code and special handling code associated with the healthcare cargo.

6. The method of claim 1, further comprising:
accessing the stored vitals data;
displaying the accessed vitals data; and
receiving additional vitals data.

7. A computer program product, comprising:
a non-transitory computer readable medium comprising instructions which, when executed by a processor of a computer system, cause the processor to perform the steps of:
identifying the presence of healthcare cargo based, at least in part, on at least one of a product code and special handling code associated with the healthcare cargo;
receiving at a first time instant, vitals data associated with the healthcare cargo;
storing the received vitals data in memory accessible by the processor;
determining a first time interval which specifies the approximate time between the first time instant when the vitals data was received and a subsequent time instant at which subsequent vitals data is to be received, and
outputting a notice when a second time interval has elapsed, wherein the second time interval is less than the first time interval.

8. The computer program product of claim 7, wherein the medium further comprises instructions which cause the processor to perform the step of displaying previously received vitals data associated with the healthcare cargo.

9. The computer program product of claim 7, wherein receiving comprises receiving the vitals data from a user via a user interface coupled to the processor.

10. The computer program product of claim 7, wherein the vitals data comprises at least one of a temperature within the healthcare cargo, an indication of whether dry ice is present within the healthcare cargo, battery power and/or voltage of batteries used for the healthcare cargo, an indication of whether the batteries have been changed or recharged, and an indication of whether the battery compartment is secured.

11. The computer program product of claim 7, wherein determining the first time interval comprises determining the first time interval based, at least in part, on at least one of user input and a pre-determined time interval set based, at least in part, on the at least one of a product code and special handling code associated with the healthcare cargo.

12. The computer program product of claim 7, wherein the medium further comprises instructions which cause the processor to perform the steps of:
accessing the stored vitals data;
displaying the accessed vitals data; and
receiving additional vitals data.

13. An apparatus, comprising:
a memory; and
a processor coupled to the memory, wherein the processor is further configured to perform the steps of:
identifying the presence of healthcare cargo based, at least in part, on at least one of a product code and special handling code associated with the healthcare cargo;
receiving at a first time instant, vitals data associated with the healthcare cargo;
storing the received vitals data in memory accessible by the processor;
determining a first time interval which specifies the approximate time between the first time instant when the vitals data was received and a subsequent time instant at which subsequent vitals data is to be received; and
outputting a notice when a second time interval has elapsed, wherein the second time interval is less than the first time interval.

14. The apparatus of claim 13, wherein the processor is further configured to perform the step of displaying previously received vitals data associated with the healthcare cargo.

15. The apparatus of claim 13, wherein receiving comprises receiving the vitals data from a user via a user interface coupled to the processor.

16. The apparatus of claim 13, wherein the vitals data comprises at least one of a temperature within the healthcare cargo, an indication of whether dry ice is present within the healthcare cargo, battery power and/or voltage of batteries used for the healthcare cargo, an indication of whether the batteries have been changed or recharged, and an indication of whether the battery compartment is secured.

17. The apparatus of claim 13, wherein determining the first time interval comprises determining the first time interval based, at least in part, on at least one of user input and a pre-determined time interval set based, at least in part, on the at least one of a product code and special handling code associated with the healthcare cargo.

18. The apparatus of claim 13, wherein the processor is further configured to perform the steps of:
accessing the stored vitals data;
displaying the accessed vitals data; and
receiving additional vitals data.
